(19) United States
(12) Patent Application Publication
(10) Pub. No.: US 2006/0024655 A1
(43) Pub. Date: Feb. 2, 2006

(54) Method and apparatus for structuring the process, analysis, design and evaluation of training

(75) Inventors: Dale S. Bambrick, Warren, MI (US); John D. Beggs, Lake Orion, MI (US); Jordan V. Brun, Novi, MI (US)

Correspondence Address: DALY, CROWLEY, MOFFORD & DURKEE, LLP, SUITE 301A, 354A TURNPIKE STREET, CANTON, MA, 02021-2714, US

(73) Assignee: Raytheon Company

(21) Appl. No.: 11/189,610

(22) Filed: Jul. 26, 2005

Related U.S. Application Data
(60) Provisional application No. 60/591,851, filed on Jul. 28, 2004.

(51) Int. Cl. G09B 3/00

(52) U.S. Cl. 434/350

(57) ABSTRACT

A learning content management method includes categorizing a curriculum into one or more curriculum areas, performing a content analysis on each of the one or more curriculum areas to identify system, subsystem and component areas of each of the one or more curriculum areas, performing a task analysis on each system, subsystem and component area identified by the content analysis, and developing terminal and enabling objectives. A media can be selected to deliver the generated training program.

### CROSS REFERENCE TO RELATED APPLICATIONS

The present application claims the benefit of U.S. Provisional Patent Application No. 60/591,851, filed on Jul. 28, 2004, which is incorporated herein by reference.

### STATEMENT REGARDING FEDERALLY SPONSORED RESEARCH

Not Applicable

### BACKGROUND

As is known in the art, training programs are useful to train or teach workers one or more job functions in certain areas. The job functions for which training is needed can be relatively complex. In the automotive field, for example, training is needed for various aspects of automotive repair (e.g. mechanical and electrical aspects of all automotive areas such as engines, drivetrain, etc. . . . ). Generating an appropriate and effective training program for each specific area/job function can be a relatively expensive and time consuming task.

### SUMMARY

In accordance with the present invention, a process for coordinating the analysis, design development and assessment process phases of a training program to reduce overall program costs includes identifying one or more curriculum areas, identifying systems, sub-systems, and components of each curriculum area and identifying tasks within each identified system, sub-system and component.

With this particular arrangement, a technique for increasing the speed with which training programs can be developed while reducing the cost of development is provided. By collecting and coordinating into one Master Course Component Objectives Table (MCCOT), all relevant information needed for training program development is stored and organized in a single source.

Appropriate training program platforms in which the MCCOT can find application include but are not limited to manufacturing platforms, technical platforms and military platforms. Additionally the MCCOT can also be applied in less technical areas such as finance, engineering processes, retail, management development and sales and marketing.

To achieve reductions in the overall cost of developing and implementing training programs, instruction should include comprehensive and streamlined processes. This is achieved by providing a systematic process that structures and streamlines the processes required to develop a training program including but not limited to analysis (including content analysis, task analysis and gap analysis) and design (including design of curriculum modules, performance objectives, media scope and media selection). The MCCOT is a table that captures the results of these analysis and design activities and communicates detailed specifications to development and assessment teams. The MCCOT can be implemented as a database (e.g. a sequel database) and used as an automated tool with which reports can be generated.

There has been no known previous attempt to coordinate into one master table the analysis, design and development and assessment of a blended learning curriculum.

The MCCOT process structures the content analysis of a curriculum by dividing the curriculum into a consistent set of master areas. Each master area is further divided into a consistent set of master system modules. Each master system module comprises a list of key components. The MCCOT process structures the task analysis by assigning to each key system, sub-system, and component a few types of terminal behaviors: diagnosis and service as an example. Depending on the industry, these terminal behaviors will vary; this document will continue to use diagnosis and service.

The MCCOT structures the gap analysis by using customer input to prioritize each master performance using predefined criteria. For example, in one embodiment, the following three criteria are used: (1) frequency of performance, (2) degree of difficulty to perform, (3) degree of difficult to learn, and (4) importance to business operations. The scores on these three variables can be used to determine customer priorities.

As noted above, the MCCOT structures the curriculum design by dividing the curriculum into a consistent set of master system modules. To the extent a curriculum is stable, these master system modules can be utilized as reusable learning objects.

The MCCOT process structures the design activities by assigning to each prioritized performance a master set of terminal objectives. These objectives are for an example and are not limited to (1) apply understanding of operation, (2) diagnose and (3) service. Using a well accepted learning theory taxonomy (Merrill), each of the terminal objectives can be further defined as: fact, concept, procedure, process and principle.

The MCCOT process systematically structures the media selection decisions by using a decision tree that is based upon a ranked order of the media preferences. Factors determining media preferences include but are not limited to: type of performance customer solution space, objective, appropriateness to the learner, cost of development, cost of delivery and potential for throughput.

In applications in which a variety of development departments are concurrently working on the same curriculum path, the MCCOT serves as a coordinating tool. It also coordinates assessment team activities by easily communicating content objectives.

By serving as a coordinating tool, the MCCOT allows the inclusion of all of the above development activities into one easily referenced master table or database.

There is no known product that has successfully and comprehensively structured and streamlined the analysis, design, development, implementation, certification and assessment (evaluation) activities of a blended learning program in one database using an automated tool.

In accordance with the present invention, an apparatus for establishing a training system for a learner includes means for identifying tasks within one or more systems, subsystems and components for a curriculum area, means for auditing training objectives to meet the identified tasks, means for selecting appropriate media to deliver the training objectives to the learner; and means for developing appropriate performance measurements for the training objectives. With this particular arrangement, an apparatus for establishing a training system which streamlines the analysis, design development and assessment activities in one database is provided. In one embodiment, the performance measurements correspond to test items and the test items are associated with a test items database.

In accordance with the present invention, a process for establishing training for a learner includes identifying one or more tasks within at least one system, at least one subsystem and at least one component in a curriculum area; developing training objectives to meet the one or more identified tasks; selecting appropriate media to deliver the training objectives to the learner; and providing appropriate performance measurements for the training objectives. With this particular arrangement, a technique for streamlining the analysis, design development and assessment of a training program is provided. In one embodiment, providing appropriate performance measurements for the training objectives corresponds to providing test items for the training objectives and can further includes associating the test items with a test items database.

In accordance with a still further aspect of the present invention, a process includes (a) categorizing a customer curriculum into one or more curriculum areas, (b) performing a content analysis on each of the one or more curriculum areas to identify system, subsystem and component areas of each of the one or more curriculum areas, (c) performing a task analysis on each system, subsystem and component areas identified by the content analysis; and (d) developing terminal and enabling objectives. With this particular arrangement, a process which provides reusable learning objectives is provided. By dividing a curriculum into a consistent set of master system modules, the master system modules can be utilized as reusable learning objects. In one embodiment, the process includes applying the terminal and enabling objectives to generate a training lesson and can further include assigning a media to deliver training objectives to an end user.

In accordance with a still further aspect of the present invention, a system which structures the process, analysis, design and development of training includes a meta-data tagging schema for implementing a meta-data tagging scheme; a master system module element for defining one or more master system modules, a course objectives element, and a media selection element.

In accordance with a still further aspect of the present invention, a system includes a database management system including a master course component objectives table (MCCOT) and one or more databases coupled to said MCCOT.

In accordance with yet another aspect of the present invention, a system which structures the process, analysis, design development and evaluation of training includes an analysis processor for predefining one or more course modules, an evaluation processor coupled to said analysis processor, curriculum management processor coupled to said analysis processor, a system integration processor coupled to said curriculum management processor and an administration processor coupled to said analysis processor, said evaluation processor, said curriculum management processor and said system integration processor.

In accordance with yet another aspect of the present invention, an engine for an instructional system design processor includes a processor for analyzing instructional needs, a processor for designing an instructional process, means for developing an instructional process, means for implementing the instructional process, and means for evaluating the instructional process.

In accordance with yet another aspect of the present invention, a method for establishing a training system for a learner includes identifying a set of components within the training system, performing a content task analysis on each of the identified set of components, wherein the content task analysis identifies one or more training procedures for a learner in a training situation and defining a set of learner tasks for each of the one or more training procedures.

In accordance with yet another aspect of the present invention, a database includes an analysis module for predefining one or more course modules; an evaluation module coupled to said analysis module, said evaluation module for performing evaluation on one or more of: students, Instructors, Courses, Curriculum, Teams, Departments, Corporations, Training Return on Investment; a curriculum management module coupled to said analysis module, said curriculum management module for auditing learning content and maintaining the quality and currency of training; a system integration module coupled to said curriculum management module said system integration module for providing a portal to other information management systems; an administration processor module to said analysis module, said evaluation module, said curriculum management module and said system integration module, said administration processor module for controlling data input by means of validation tables and a security schema; a work scope module coupled to said system integration module and said administration module, said work scope module for identifying the effort needed to complete training design and development; and a media selection module coupled to said evaluation module, said administration module and said work scope module, said media selection module for looking at objectives and using one of a plurality of different educational taxonomies and for using the selected taxonomy to identify which media or mix of media is best for learner material and client material

In one embodiment, the analysis module includes a task list table for storing each task associated with a system, subsystem and component of curriculum area; a learner analysis table, an enabling objectives table and a terminal objectives table.

### BRIEF DESCRIPTION OF THE DRAWINGS

The foregoing features of this invention, as well as the invention itself, may be more fully understood from the following description of the drawings in which:

FIG. 1 is a block diagram of a learning content management system;

FIG. 2 is a block diagram of a plurality of modules which comprise a master course component objectives table (MCCOT);

FIG. 3 is a column-group representation of a master course component objectives table (MCCOT);

FIG. 4 is a flow diagram illustrating a process for generating a training material for an identified curriculum;

FIG. 4A is a block diagram illustrating generation of a training material for an identified curriculum;

FIG. 5 is a block diagram of a plurality of modules which comprise an analysis module;

FIG. 6 is a block diagram of a plurality of modules which comprise a curriculum management module;

FIG. 7 is a block diagram of a plurality of modules which comprise a system integration module;

FIG. 8 is a block diagram of a plurality of modules which comprise an administration module;

FIG. 9 is a block diagram of a plurality of modules which comprise a work scope module;

FIG. 10 is a block diagram of a plurality of modules which comprise an evaluation module;

FIG. 11 is a block diagram of a plurality of modules which comprise a media selection module; and

### DETAILED DESCRIPTION

The inventive systems and techniques provide for the analysis, design development and assessment (evaluation) processes required to coordinate these phases in order to reduce the overall time and costs of developing and implementing a training program. To achieve this reduction, instruction should include comprehensive and streamlined processes.

The inventive master course component objectives table (MCCOT) includes an exemplary systematic process that structures and streamlines the illustrative following components: analysis, e.g., content analysis, task analysis, gap analysis; and design, e.g., curriculum modules, performance objectives, media scope, media selection. The MCCOT is a table that captures the results of these analysis and design activities and easily communicates detailed specifications to the development and assessment teams. As an automated tool and database, the overall process will be further streamlined and reports will be easily generated.

The MCCOT process structures the content analysis of a curriculum by dividing the curriculum into a consistent set of master areas. Each master area is further divided into a consistent set of master system modules. Each master system module comprises a list of key components. The MCCOT process structures the task analysis by assigning to each key component one and/or two master performances: for example diagnosis and service.

The MCCOT structures the gap analysis by using customer input to prioritize each master performance using the following three criteria: frequency of performance, degree of difficulty to perform, degree of difficulty to learn and importance to business operations. The scores on these three variables determine customer priorities.

As noted above, the MCCOT structures the curriculum design by dividing the curriculum into a consistent set of master system modules. To the extent a curriculum is stable, these master system modules can be utilized as reusable learning objects.

The MCCOT process structures the design activities by assigning to each prioritized performance a master set of terminal objectives: for example, apply understanding of operation, diagnose and service. Using a well accepted learning theory taxonomy such as Merrill's Component Display Theory, each of these three terminal objectives can be further classified as: fact, concept, procedure, process and principle. Other learning theories familiar to one of ordinary skill in the art can also be utilized such as those proposed by Bloom and/or Gagne.

In an exemplary embodiment, the MCCOT process systematically structures the media selection decisions by using a decision tree that is based upon a ranked order of the media preferences (factors determining media preferences include: type of performance objective, appropriateness to the learner, cost of development, cost of delivery and potential for throughput).

The MCCOT serves as a coordinating tool for the variety of development departments working on the same curriculum path concurrently. It also coordinates assessment team activities by easily communicating content objectives.

One novel of feature of this process/tool is the inclusion of the above-described development activities into one easily referenced master table. The inventive automated tool structures and streamlines the analysis, design development and assessment activities (of a blended learning program) in one database.

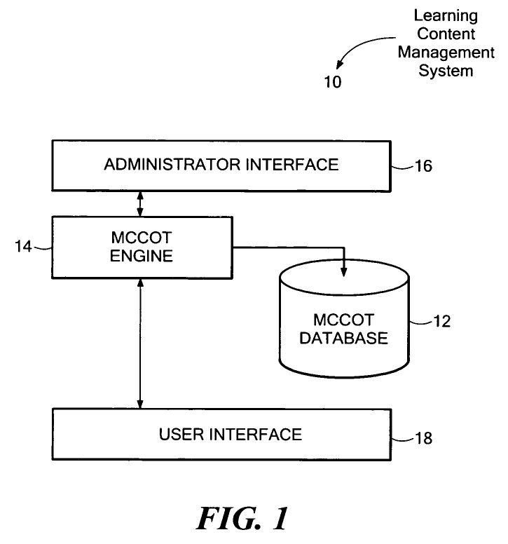

Referring now to FIG. 1, a learning content management system 10 includes a master course component objectives table (MCCOT) 12 having an MCCOT engine 14 coupled thereto. An administration interface 16 and a user interface 18 are also coupled to the MCCOT engine 14 and thus, to the MCCOT database 12. The system is thus an engine for an instructional systems design process.

The MCCOT system drives an instructional process (e.g. a standardized instructional process), such as one that the training industry accepts. In the present invention, the analysis, design development, implementation, evaluation are included in the MCCOT such that the entire process is captured and structured in the database. While the MCCOT system is primarily shown and described in conjunction with automotive training, it is understood that the invention is applicable to curriculums in general for which it is desirable to generate a training program.

The MCCOT system structures and streamlines the analysis, design and development phases of courseware development. The system also coordinates the media selection activities within a blended learning program and manages courseware content at the curriculum, course and module levels. The MCCOT tool further aligns level one and level two evaluation results for revisions at the curriculum, course and module levels.

By structuring and streamlining the analysis, design and development phases of courseware development, the follow benefits accrue: the system streamlines analysis activities by structuring and documenting content analysis at the systems, subsystems and component levels. The system structures and documents task analysis (component-diagnosis/service); structures and documents gap analysis (ratings: difficulty/importance/frequency); and streamlines customer feedback (data collection and data input for gap analysis).

The MCCOT tool streamlines design activities structuring the design of reusable learning modules (common vehicle areas with common systems); by structuring metadata tagging schemes; by pre-structuring system modules (operation lessons, diagnostic lessons and service lessons); by pre-structuring development of objectives (pre-selected: three terminal/eight sub terminal); and by documenting objectives (fact/component/procedure/process/principle-remember/apply).

The MCCOT tool streamlines placement assessment activities by coordinating placement assessment activities (metadata tagging ties test items to objectives) and by coordinating prescriptive learning pre-tests vs. certification post-tests.

The MCCOT tool coordinates the media selection activities with a blended learning program. This leads to the benefit of streamlining development activities by structuring systematic media selection (media preferences based on ranked media decision tree); document assignment of objectives in blended learning solutions program; by structuring and documenting media development scope; and by documenting media delivery time.

The MCCOT tool also manages courseware content at the curriculum, course and module levels. This leads to the following benefits: it provides analysis reports such as comprehensive task analysis for each curriculum area; gap analysis results for each curriculum area; and prioritized performances for each curriculum area. The MCCOT tool also provides the following development reports: the number of media elements per system module/per curriculum area; the number of content pages per system module/per curriculum area; course assets (tools list, vehicles, etc.) for each curriculum course or module. The MCCOT tool also provides the following deliverable reports: all system modules within each curriculum area; all component and system operation objectives within each system module; all diagnostic and service procedures within each system module; alignment of operation, diagnosis and service objectives across the blended program; alignment of assessment questions to operation, diagnosis, service objectives; and media delivery timelines for each system module.

The MCCOT also aligns level one and level two evaluation results for revisions at the curriculum, course and module levels. This provides the benefit of providing the following level one and level two evaluation reports: level one results for each curriculum area, course or module; level two results for each curriculum area, course, module or objective; and it streamlines and pinpoints refresh efforts at the modular level.

The master course component objectives table finds application when developing a new curriculum or in a refresh development effort with intentions to convert the curriculum to a reusable learning object economy and/or an electronic performance support system.

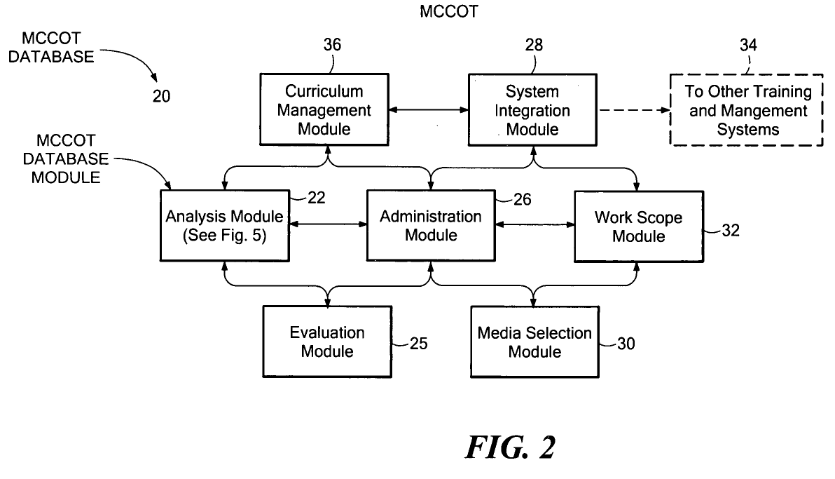

Referring now to FIG. 2, an MCCOT database 20, which may be similar to MCCOT database 12 described above in conjunction with FIG. 1, includes a plurality of database modules including an analysis module 22 coupled to an evaluation module 25 and a curriculum management module 36. The curriculum, analysis and evaluation modules are each coupled to an administration module 26. The evaluation module 25 is also coupled to a media selection module 30 and curriculum management module 36 is coupled to a system integration module 28. The system integration module 28 and media selection module 30 are each coupled to the administration module 26 and work scope module 32. The system integration module 28 is also coupled to other training and management systems 34.

As can be seen, the modules of the MCCOT process are interconnected. The interdependance of the modules allows for greater manipulation of the data while minmizing processing time. The MCCOT is designed to empulate an expended ADDIE process and to do so using a relational database structure.

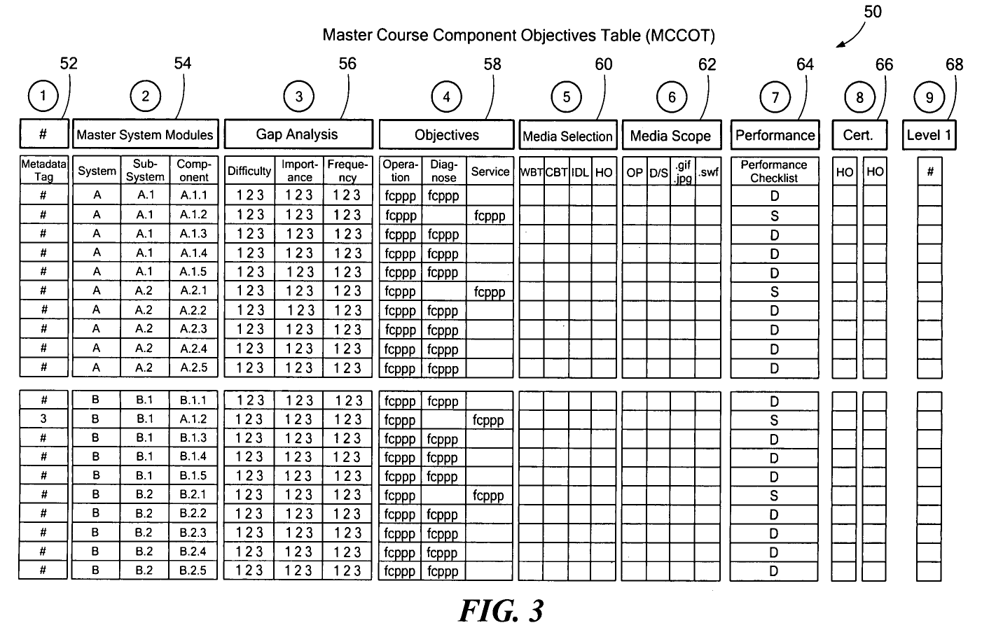

Referring now to FIG. 3, a master course component objectives table 50 includes a metadata tag 52 which is utilized in a metadata tagging scheme. An intelligent metadata tagging scheme is an exemplary implementation of a learning content management system and reusable learning objects economy. The tagging number identifies the customer, curriculum area, system, sub-system, part/component, objective, performance and may include other useful data such as media elements.

In an exemplary embodiment, the MCCOT table 50 includes the following fields: column group one: metadata tag scheme 52 (identification of customer, area, course, module, component, objective, etc.); a column group two 54: which corresponds to master system modules (pre-structured reusable learning objects); a column group three 56 corresponding to gap analysis (customer priorities); a column group four 58 corresponding to objectives (common set; three terminals, eight sub-terminals); a column group five 50 corresponding to media selection (ranked decision tree); a column group six 62 corresponding to media scope (page count, number of images, number of animations); a column group seven 64 corresponding to performance (performance checklists based upon content-task analysis); a column group eight 66 corresponding to certification (hands-on and certification coordination); a column group nine 68 corresponding to level one and level two evaluation at the master system module level. It should be noted that additional columns may be added to accommodate other customer and supplier needs.

The column group two master system modules 54 is used in the MCCOT to pre-structure the customer's curriculum content into master curriculum areas and master system modules within each curriculum area. Each system module includes a list of all subsystem and relevant parts/components for that system. Assigned to each part/component is a performance (diagnosis or service). The master list 54 of system modules imposes a logical structure on the curriculum areas in a manner that maximizes potential reusable learning objects. To the extent that one customer's master curriculum area break down, there is another customer's curriculum area break down, there is the potential for reuse.

For example, in an automotive curriculum, there is a common logical breakdown of systems within each vehicle area. Given that most automotive customers have the same curriculum area breakdown, there is great potential for the reuse of the system modules.

For example, a curriculum area may be identified as vehicle area. Under each vehicle area are things such as engine performance, diesel engine performance, automatic transmission, engine mechanical repair, manual drive line, brakes, steering and suspension, mechanical/electrical body repair, HVAC, electrical/electronics, body structural and foundation. In the engine performance vehicle area, for example, the master systems module at the course level may include engine performance certification area (course level). This would further breakdown into fuel system, ignition system, engine control systems, air induction system (intake and exhaust), emission control systems, mechanical systems (lightly) and combustion theory. Diesel engine performance at the course level, however, may include a diesel engine performance certification area which, in turn, would include mechanical system, fuel system, engine control systems (cold starting), air induction, turbo-charging and exhaust system, emission control system, cold starting system and combustion theory. Another curriculum area may be for automatic transmission and an automatic transmission certification area at the course level may include torque converter, mechanical system, hydraulic system, electrical system, and torque multiplication. It should be appreciated that associated with each part/component in column group two is a specific/task that is identified in column group seven. The list of systems, subsystems and parts/component structures, the content analysis and the related performance to each part/component structures the task analysis. Thus column group two and column group seven are included as part of the content analysis and task analysis.

Column group three 56 corresponds to gap analysis. The customer's priorities are captured in the gap analysis using average scores from the well known “DIF” method. DIF stands for difficulty-importance-frequency. With respect to difficulty, the question is given the base line and average performer, how difficult is the task: 1 somewhat difficult, 2 difficult, 3 very difficult. Importance is given the customer's criteria, how important is the performance to the business operations: 1 somewhat important, 2 important, 3 very important. With respect to frequency, the questions is given a six to twelve month period, how often is the task performed: 1 somewhat regularly, 2 regularly, 3 very frequently.

The gap analysis 56 using the DIF method can be in the form of an electronic survey that can be easily distributed to a variety of customers (managers, subject matter experts, field technicians). Results can be easily collected and imported into the automated tool for immediate analysis. Based upon the results and customer criteria, key performances are distinguished from non-key performances. Column group seven 64 illustrates the performance checklist and shows the average scores from the DIF method.

Column group four 58 corresponds to the course objectives. To meet the terminal performance, there are master terminal objectives: For example, applying understanding of operation, diagnose or service. These three can be further broken down into eight master sub-terminal objectives: operation-variant operation; diagnose-symptom diagnosis (experiential and operational) and a tool diagnosis (manual and electrical/electronic tools); service-repair (tools and procedures) and replace (tools and procedures). The well known Merrill's taxonomy provides five potential instructional objectives for each of the eight sub-terminal objectives: facts, concepts, procedures, processors or principles. In one embodiment, a color code may be used to communicate the depth of the instructional objectives in Merrill's taxonomy. For example, blue may equal fact of concept; yellow may equal simple process or published procedure; red may correspond to a detailed process, non-published procedure or principle.

Column group five 60 corresponds to media selection. The systematic media selection process is based upon the media delivery options (solution space) and the customer's priorities. The process first involves the rank ordering of media preferences based upon business considerations such as development costs, delivery costs, and a potential fourth group. For business considerations, ranking the most preferred delivery options first and the least preferred delivery options last may be an exemplary embodiment. The process then involves learner considerations using the following steps: first, identify the instructional objective; second, ask whether the preferred media option (given its properties) is capable of effectively delivering the instructional objective; third, if yes, then choose that media delivery option; fourth, if no, proceed to the next preferred media delivery option and repeat steps two and three.

The results of the systematic media selection process are captured in the objectives column 58 (column group four). In this way, one can identify the depth to which the objective is treated in the corresponding selected media. The table also shows alignment of objectives with the terminal performance noted in the performance checklist.

Given the instructional objective and the delivery media, the development effort for each system module can be scoped according to: page count (based upon average paragraphs and required/average sentences required) and media count (e.g., number of digital photos, line art drawings, 3D drawings, animations, etc.). It should be noted that the media scope based upon the system module can also effectively project media effort for quoting new business proposals. It should further be noted that media delivery times can be calculated per system module, using the estimated page count.

The MCCOT database also allows for additional columns to capture HO (hands on training) assets (parts, tools, vehicles, etc.) in new model features data. The MCCOT can provide a tracking system for placement assessment test items. Each question will reference metatag data number which automatically matches the test item to the objective in column group four 58. Because the test items can be categorized according to the level of the objective, the test bed can distinguish which test items are appropriate for prescriptive learning, placement assessment or certification.

Using column groups four 58, seven 64 and eight 66, the MCCOT provides a roadmap for the subject matter expert and the instructional systems designer for planning and executing the development activities in a manner that ensures the integrity of the certification program. Development efforts are matched to meet the terminal performances. Certification exercises have supporting content.

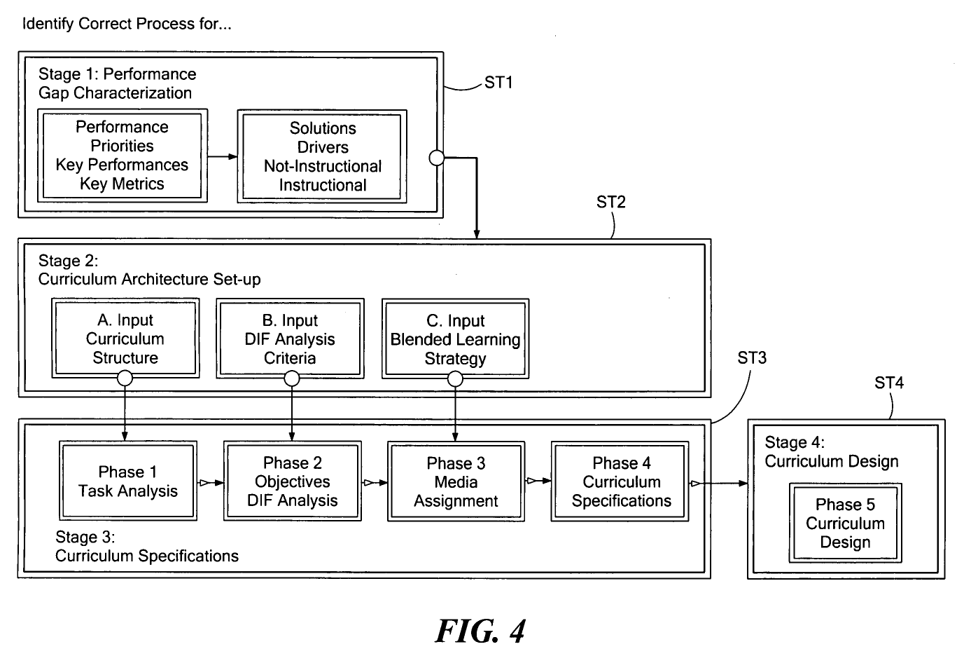

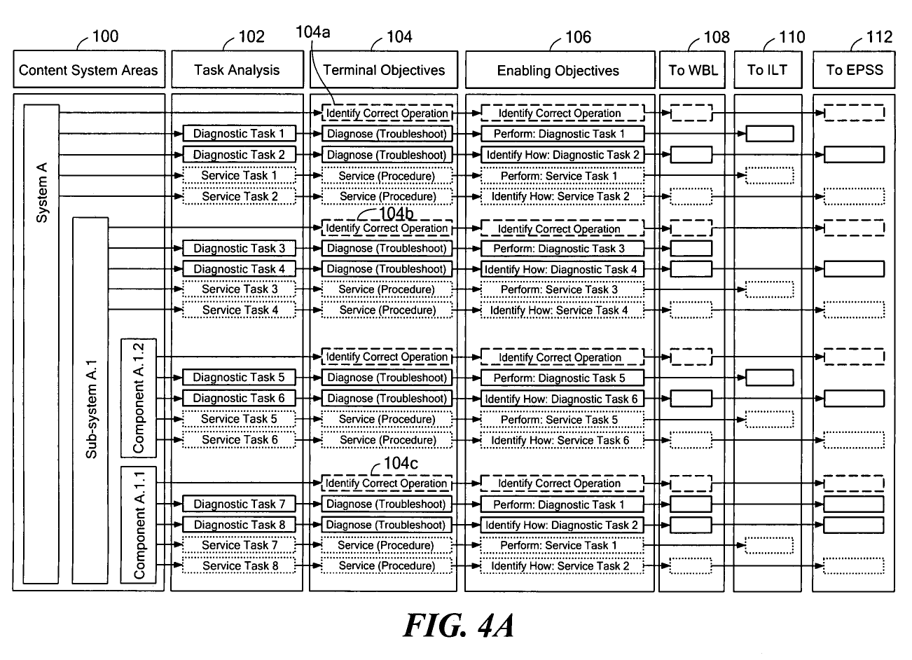

FIG. 4 shows an exemplary sequence of steps to generate courseware. In a first stage, ST1, performance priorities are identified, such as key performance areas and key metrics to evaluate performance. From the performance metrics, solution drivers are identified, which can include instructional and non-instrunctional components. In a second stage ST2, the curriculum architecture is established. In this stage, inputs are received from the first stage ST1 to define curriculum structure, DIF analysis criteria, and blended learning strategy.

In a third stage ST3, curriculum specifications are identified. In an exemplary embodiment, phase 1 includes task analysis, phase 2 includes objectives (terminal and enabling) and DIF analysis, phase 3 includes media assignment, and phase 4 includes curriculum, such as WBT assets, ILT assets, and other assets. The third stage ST3 can provide inputs to a fourth stage ST4 to design the curriculum.

Referring now to FIG. 4A, a diagram to explain the MCCOT process from initial training to EPSS. Initially, content system areas 100 are identified. In the illustrated embodiment, system A, sub-system A.1, and components A.1.1, A.1.2 are identified. After the content system areas 100 are identified at the system, sub-system and component levels, a task analysis 102 is performed to determine both diagnostic tasks and service tasks for each of the systems, sub-systems and component areas. Next, a plurality of terminal objectives 104 are identified at the system A, sub-system A1 and component levels A.1.1, A.1.2 and additionally at the task level. For example, one terminal objective for a system A is to identify correct operation 104a, one terminal objective for sub-system A.1 is to identify correct operation 104b, one terminal objective for component A.1.1 is to identify correct operation 104c. Similarly, one terminal objective for diagnostic task 1 of system A is to diagnose (troubleshoot). In an exemplary embodiment, both diagnostic tasks and service tasks have terminal objectives 104.

Each of the system, sub-subsystem, component and task blocks has enabling objectives 106. Once the system content area is identified and task analysis performed, the terminal objectives 104 are identified and enabling objectives 106, such as perform service task 1, are identified, the appropriate media outlets WBL (Web-based learning) 108, ILT (instructor-based learning) 110, and electronic performance systems (EPSS) 112 for each system, sub-system, component task and objective is identified. For example, WBL 108 can be used, instructor lead training (ILT) 110 can be used, and electronic performance systems (EPSS) 112 can be used. Each of these different media outlets is provided to delivery the course content.

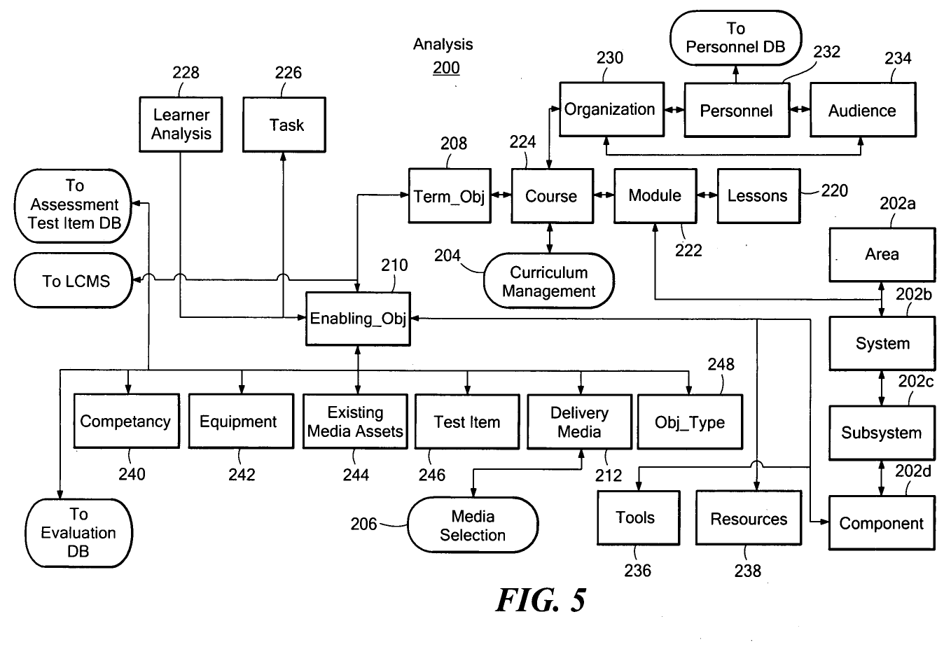

FIG. 5 shows further details of an analysis module 200 within the MCCOT database, such as the analysis module 22 of FIG. 2. During the analysis process the customer curriculum is broken out into various curriculum areas, which are broken down into its constituent components (system, sub-system, component areas) by the curriculum management module 204. Content system area, system, subsystem, and component blocks 202a-d, which can correspond to the content system areas 100 of FIG. 4A, can be used to structure a curriculum using the approach defined by the blocks. Using this approach leads to the development of reusable modules and the like. By examining and analyzing the content 202, the content can be broken down into systems and then into processes related to the systems. The structure of the MCCOT database supports the curricula area/system/sub-system/component breakdown training to allow training at the sub-system level.

From the content area, system, subsystem, and component blocks 202a-d, the analysis module 200 (e.g., element 22 of FIG. 2) generates the tasks for these blocks from which the terminal objectives 208 are generated, which can correspond to 104 of FIG. 4A. From the terminal objectives 208, the enabling objectives 210 are determined, which can correspond to 106 of FIG. 4A. From the enabling objectives 210, the media selection module 206 can communicate with a delivery media block 212 to determine the media for the various enabling objectives.

A lesson module 220 provides lessons, each of which represents an objective. Each objective relates to a task(s) generated in the task analysis. A group of lessons is organized within a module 222, and a group of modules will be organized within a course 224. A group of courses will be organized within a curriculum area. In general, objectives 208, 210, are the building blocks of instructional systems as well as the MCCOT database.

A task module 226 and a learner analysis module 228 are coupled to the enabling objects module 210. Coupled to the course module 224, an organization, personnel and audience module 230. 232, 234.

A tool module 236 and a resources module 238 are couupled to the enabling objectives module 210. A competency module 240, an equipment module 242, an existing media assets module 244, a test item module 246, and an objective type module 248 are coupled to the enabling objective module 210.

With this approach, it is possible to design a training system so that a learner learns all of the tasks for the curriculum and all of the terminal and enabling objective developments are met. It should be noted, of course, that the content and task analysis process can be performed as an integrated step.

Referring again to FIG. 2, the MCCOT database 20 organizes content objectives by category and then organizes the assignment of each objective to the appropriate media delivery, resulting in a “blended learning approach.” The MCCOT database 20 has a series of modules that have specific uses to the overall database and process, as shown and described in more detail below.

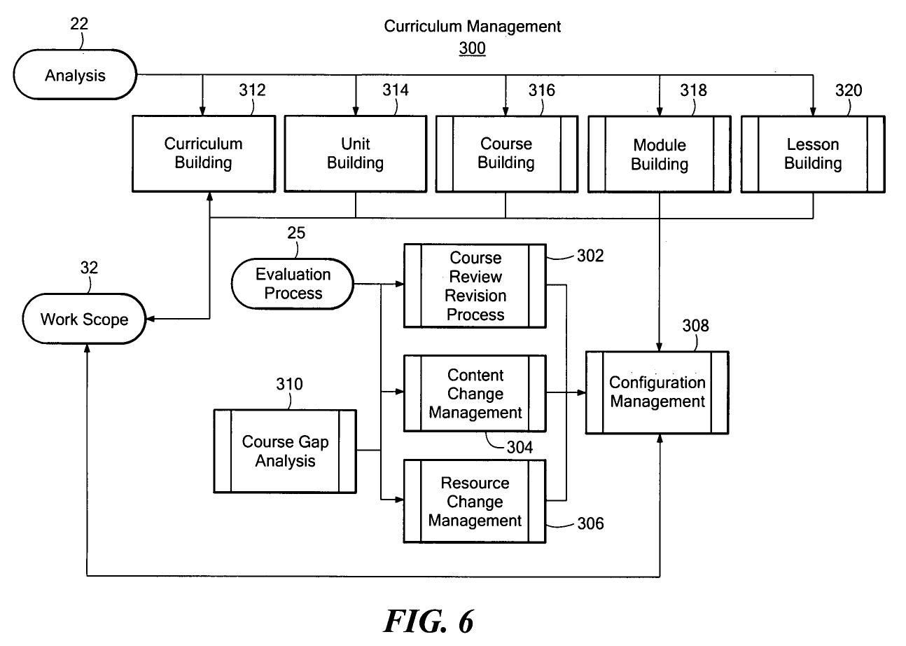

FIG. 6 shows further details of the curriculum management module 300, which can correspond to element 22 of FIG. 2 and/or 204 of FIG. 5). The curriculum module 300 communicates with the analysis module 22, evaluation module 25, and work scope module 32 of FIG. 2. In general, the curriculum management module 300 includes a course review/revision process 302 along with a content change management module 304 and resource change mangement module 306. These modules 302, 304, 306 are coupled to a configuration management (versions, date, history, etc.) module 308 and a course gap analysis module 310.

The curriculum mangement module 300 further includes a curriculum building block 312, a unit building block 314, a course building block 316, a module building block 318 and a lesson building block 320. The curriculum management module 300 of MCCOT facilitates the quick building of lessons, modules and courses. By taking the objectives, the building blocks of the MCCOT database, grouping and sequencing them to best meet the needs of the learner while being cost effective and time effective. This module will also control the external processes of Resource Management, Change Management, Configuration Management, Course Review and approval, and Gap analysis.

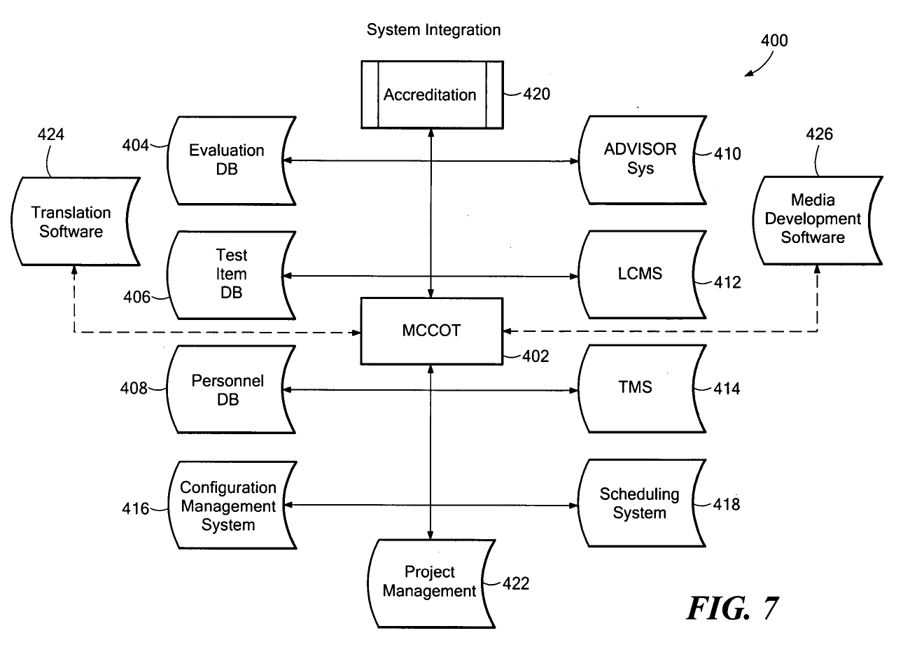

FIG. 7 shows further details of the system integration module 400, which can correspond to element 28 of FIG. 2. The system integration module 400 includes the MCCOT 402, which is coupled to various components. In an exemplary embodiment, the system integration module 400 connects to a series of databases, such as an evaluation database 404, a test item database 406, and a personnel database 408. The evaluation database 404 is coupled to a return on investiment analysis system 410, such as an ADVISOR system. The test item database 406 is coupled to the the LCMS 412 and the personnel database 408 is coupled to a Training Management System (TMS) 414. A configuration management system 416 is coupled to a scheduling system 418.

An accreditation module 420 stores data about accrediation organizations and specific accreditation criteria, i.e. North Central Association of Schools and Colleges, ASE for automobile technicians. Furthermore each of these has criteria that must be met to be accredited. These criteria are stored in this module. A project management software package 422 to project manage the development of training materials is coupled to the MCCOT 402. The system integration module 400 can further include translation software 424 and media development software 426.

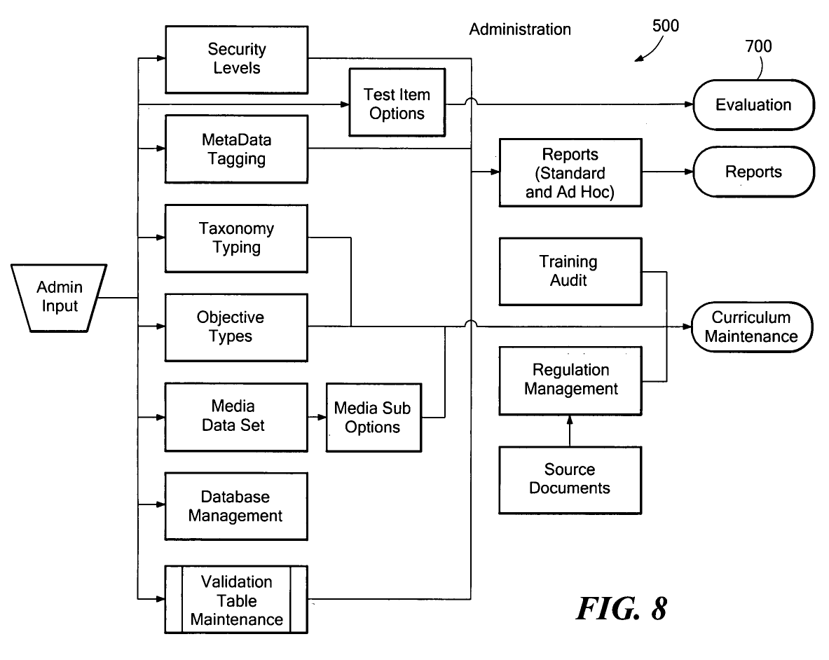

FIG. 8 shows further details of the administration module 500, which can correspond to element 26 of FIG. 2. The administration module 500 maintains validation tables that control what the user sees when working in the MCCOT 502. This module 500 also controls the security levels for users. There are designated security levels depending on the role of the individual working in the system. The security is controled by the systems administrator and is set up for each user, client, and project. The administration module interfaces with other modules of the MCCOT, such as the evaluation 700 module, either directly or indirectly. In general, the adminstration module 500 controls data entry and security in a manner well known to one of ordinary skill in the art.

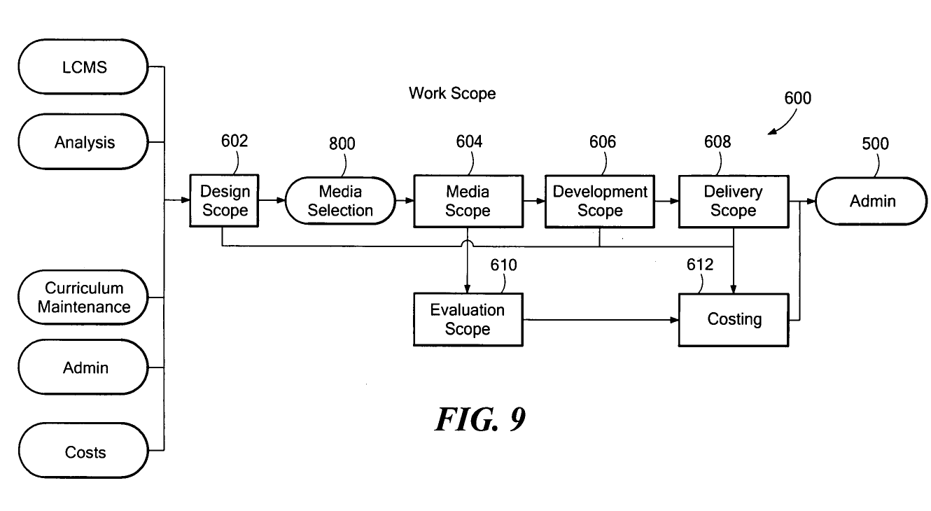

FIG. 9 shows further details of the work scope module 600, which can correspond to element 32 of FIG. 2. The media scope module 600 uses development metrics to provide an estimation of planned development costs and to capture actual development costs. The media scope module also provides an estimation of delivery durations and captures actual delivery durations. In an exemplary embodiment, the work scope module 600 includes a design scope module 602 coupled to the media selection module 800, along with a media scope module 604, a development scope module 606, and a delivery scope module 608. The module can futher include an evaluation scope module 610 and a costing module 612.

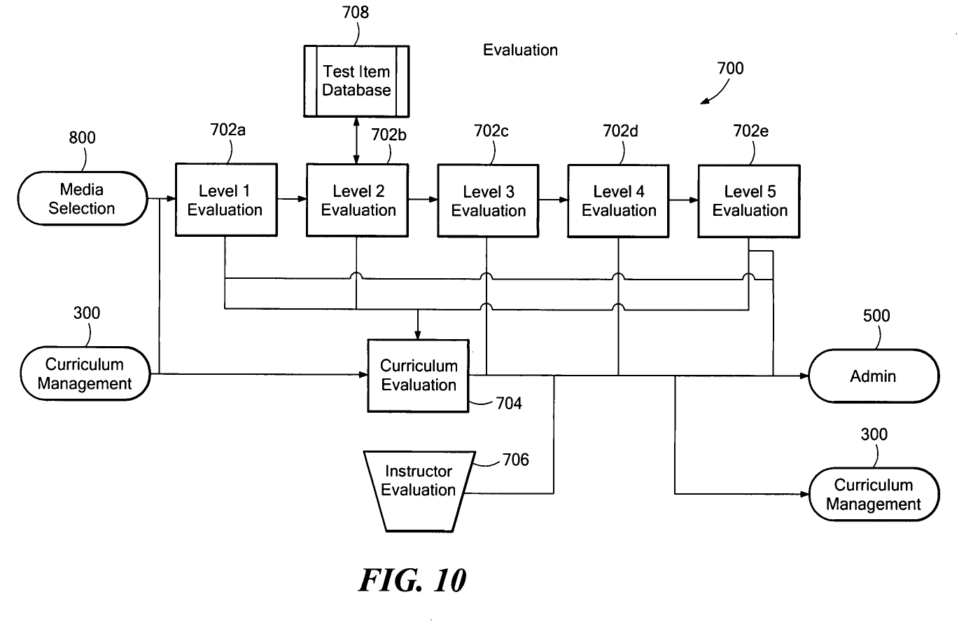

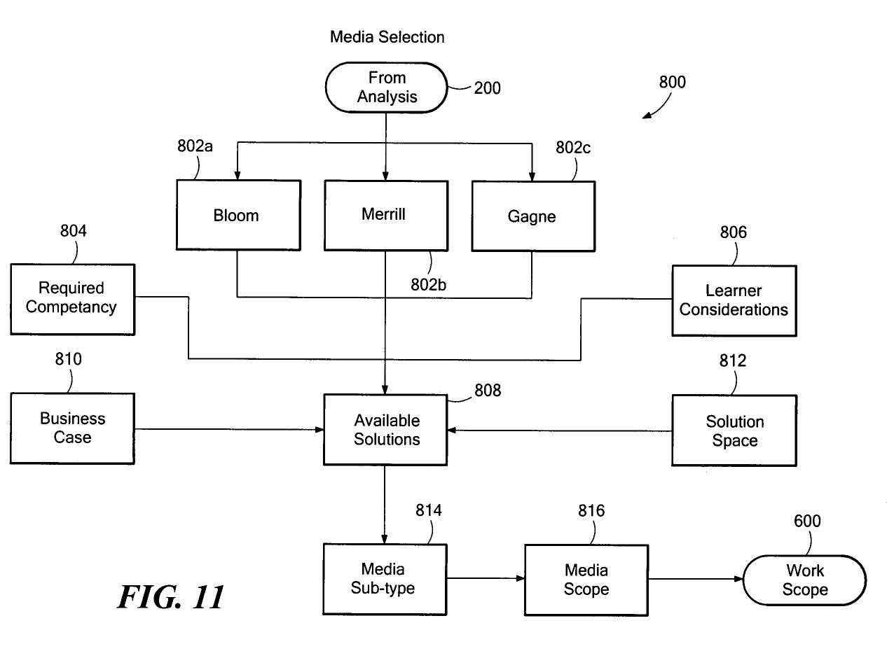

FIG. 10 shows further details of an evaluation module 700, which can correspond to 25 of FIG. 2. In an exempalry embodiment, the evaluation module includes five levels 702a-e of evaluation. In one particular embodiment, these levels 702 of evaluation follow Kirkpatrick's and Phillip's models of evaluation, which are well known to those of ordinary skill in the art. In addition to the evaluation levels, the evaluation module 700 allows for the storage of curriculum evaluation 704 and storage of instructor evaluations 706. The evaluation module interfaces with a test item database 708, as well as the admininistration module 500, curriculum management module 300, and media selection module 800 (FIG. 11).

The media selection module 800, as shown in FIG. 11, examines the curriculum objectives and, in one particular embodiment, uses one of three different educational taxonomies, shown as the so-called Bloom, Merill, and Gagne taxonomies 802a, b, c, to identify which media is best suited for learner and client material. This module 800 allows one to select media subtypes (e.g. production level of WEB based training or video production). After the delivery medial sub types are identified for the modules, the media selection module 800 assists users in scoping and costing development efforts. The media selection module interfaces 800 with the work scope module 600 and the analysis module 200.

The media selection module 800 can include a required competency module 804 and a learner considersations module 806 coupled to an available solutions module 808. The media selection module 800 can further include a business case module 810, a solution space module 812, a media sub-type module 814, and a media scope module 816.

The work scope module 600 of FIG. 9 takes information from the media selection module 800, historical costing factors, and evaluation scope (FIG. 10 five levels 702a-e, when the target level is selected each subsequent level must be completed before reaching the target level). The MCCOT database may also be coupled to other database systems such as an evaluation database, an ADVISOR database, a test item database, project management system and a learning content database. This is done through the system integration module. The media selection module interfaces with the LCMS (Learning Content Management System), analysis module, curriculum maintenance module, and the administration mocule.

Having described preferred embodiments of the invention it will now become apparent to those of ordinary skill in the art that other embodiments incorporating these concepts may be used. Accordingly, it is submitted that that the invention should not be limited to the described embodiments but rather should be limited only by the spirit and scope of the appended claims.

What is claimed is:

1. A method, comprising:
(a) categorizing a curriculum into one or more curriculum areas and sub-areas;
(b) performing a content analysis on each of the one or more curriculum areas to identify system, subsystem and component areas of each of the one or more curriculum areas;
(c) performing a task analysis on each system, subsystem and component area identified by the content analysis; and
(d) developing terminal and enabling objectives.

2. The method of claim 1, further comprising applying the terminal and enabling objectives to generate a training lesson.

3. The method of claim 2 further comprising assigning a media to deliver the training lesson to an end user.

4. The method of claim 3, further including assigning the media to one or more media delivery options.

5. The method of claim 1, further including performing a performance gap analysis.

6. The method according to claim 5, wherein the performance gap analysis includes one or more of frequency of performance, degree of difficulty to perform, degree of difficulty to perform, and importance to objectives.

7. The method according to claim 1, further including generating a master course component objectives table (MCCOT) including metatag data, system modules, task analysis, performance gap analysis, objectives, and media selection.

8. A learning content mangement system, comprising:
a processing engine; and
a database coupled to the processing engine, the database including
a meta-data tagging schema for implementing a meta-data tagging scheme;
a master system module element for defining one or more master system modules;
a course objectives element; and
a media selection element.

9. The system of claim 8 further comprising:
a performance gap analysis data element; and
a media scope data element;

10. The system of claim 9 further comprising:
a performance and performance resources field;
a certification test item field a test item field; and
an evaluation field.

11. The system according to claim 8, further including a media selection module to select a delivery media.

12. The system according to claim 8, further including an analysis module to analyze content areas from a curriculum.

13. A method for establishing a training system for a learner, the method comprising:
identifying a set of components within the training system;
performing a content task analysis on each of the identified set of components, wherein the content task analysis identifies one or more training procedures for a learner in a training situation; and
defining a set of learner tasks for each of the one or more training procedures.
